(19) United States
(12) Patent Application Publication
(10) Pub. No.: US 2018/0233058 A1
(43) Pub. Date: Aug. 16, 2018

(54) INFORMATION PROCESSING DEVICE, INFORMATION PROCESSING METHOD, AND PROGRAM

(71) Applicant: SONY CORPORATION, Tokyo (JP)

(72) Inventors: Masaaki ISOZU, Tokyo (JP); Takehiko SASAKI, Kanagawa (JP); Kazuhiro WATANABE, Tokyo (JP); Yoshihiko IKENAGA, Tokyo (JP); Shinji TAKAE, Tokyo (JP)

(73) Assignee: SONY CORPORATION, Tokyo (JP)

(21) Appl. No.: 15/750,523

(22) PCT Filed: Jun. 29, 2016
(86) PCT No.: PCT/JP2016/069352

§ 371 Date: Feb. 6, 2018

(30) Foreign Application Priority Data
Oct. 13, 2015 (JP) 2015-202063

(51) Int. Cl. G09B 7/04

(52) U.S. Cl. CPC G09B 7/04; G09B 19/025

(57) ABSTRACT

[Object] To provide an information processing device, information processing method, and program, capable of determining a next question depending on an answer to a relevant question used to derive a correct answer to a question, thereby improving learning efficiency.

[Solution] An information processing device including: a communication unit configured to transmit a question and a relevant question to a client terminal and receive an answer to the relevant question from the client terminal, the relevant question being present with passage of time and being used to derive an answer to the question; and a control unit configured to determine a next question to be transmitted on a basis of the answer to the relevant question.

### TECHNICAL FIELD

The present disclosure relates to an information processing device, an information processing method, and a program.

### BACKGROUND ART

Various test approaches for achieve accurate evaluation of learner's abilities in the field of learning have recently been proposed. In one example, item response theory (IRT) is proposed for measurement of the learner's characteristics, the difficulty level, and discrimination ability for each evaluation item on the basis of a response to an evaluation item group. IRT makes it possible to achieve accurate measurement of the learner's abilities by excluding factors that cause difficulties in determining learner's ability, such as luck or question's difficulty level.

One technique in such a learning field, in one example, is Patent Literature 1 below that disclosed a learning test method of recording an answered time point when a learning test is given to a user and preparing a next test on the basis of an answering time calculated from the answered time point, thereby improving the user's learning effect. In addition, Patent Literature 2 below discloses a method of measuring the answering time for a plurality of questions in a test using a computer and estimating the ability value of the examinee on the basis of the answering time.

### CITATION LIST

### Patent Literature

Patent Literature 1: JP 2002-108199A
Patent Literature 2: JP 2007-271886A

### DISCLOSURE OF INVENTION

### Technical Problem

Meanwhile, the accurate measurement of learner's abilities using IRT necessitates the learner to solve a large quantity of questions. This however puts a heavy burden on the learners who are to solve a large quantity of questions in bulk inquiring n about their abilities to think, judge, express, or the like as a tendency of questions in recent educational environments around the world.

In view of this, the present disclosure proposes an information processing device, information processing method, and program, capable of determining a next question depending on an answer to a relevant question used to derive a correct answer to a question, thereby improving learning efficiency.

### Solution to Problem

According to the present disclosure, there is proposed an information processing device including: a communication unit configured to transmit a question and a relevant question to a client terminal and receive an answer to the relevant question from the client terminal, the relevant question being presented with passage of time and being used to derive an answer to the question; and a control unit configured to determine a next question to be transmitted on a basis of the answer to the relevant question.

According to the present disclosure, there is proposed an information processing method executed by a processor, the method including: transmitting a question and a relevant question to a client terminal and receiving an answer to the relevant question from the client terminal, the relevant question being presented with passage of time and being used to derive an answer to the question; and determining a next question to be transmitted on a basis of the answer to the relevant question.

According to the present disclosure, there is proposed a program causing a computer to function as: a communication unit configured to transmit a question and a relevant question to a client terminal and receive an answer to the relevant question from the client terminal, the relevant question being presented with passage of time and being used to derive an answer to the question; and a control unit configured to determine a next question to be transmitted on a basis of the answer to the relevant question.

According to the present disclosure, there is proposed an information processing device including: a communication unit configured to receive a question and a relevant question from a server and transmit an answer to the relevant question to the server, the relevant question being presented with passage of time and being used to derive an answer to the question; a presentation unit configured to present the question; and a control unit configured to sequentially present the relevant question to the presentation unit with passage of time. The communication unit receives a next question determined on a basis of the answer to the relevant question.

### Advantageous Effects of Invention

According to the present disclosure as described above, it is possible to determine a next question depending on an answer to a relevant question used to derive a correct answer to a question, thereby improving learning efficiency.

Note that the effects described above are not necessarily limitative. With or in the place of the above effects, there may be achieved any one of the effects described in this specification or other effects that may be grasped from this specification.

### BRIEF DESCRIPTION OF DRAWINGS

FIG. 1 is a diagram illustrated to describe the overall configuration of a learning support system according to an embodiment of the present disclosure.

FIG. 2 is a block diagram illustrating a configuration example of a user terminal according to the present embodiment.

FIG. 3 is a diagram illustrated to describe an example of a question preparing screen according to the present embodiment.

FIG. 4 is a diagram illustrating an example of a screen of preparing relevant information according to the present embodiment.

FIG. 5 is a block diagram illustrating a configuration example of a server according to the present embodiment.

FIG. 6 is a diagram illustrated to described a comprehension level calculation method according to the present embodiment.

FIG. 7 is a flowchart illustrating question-setting control processing according to the present embodiment.

FIG. 8 is a flowchart illustrating display control processing of each question according to the present embodiment.

FIG. 9 is a diagram illustrated to described an example of a question presentation screen according to the present embodiment.

FIG. 10 is a diagram illustrated to describe a display example of relevant information according to the present embodiment.

FIG. 11 is a diagram illustrated to describe a display example of relevant information according to the present embodiment.

FIG. 12 is a diagram illustrated to describe a display example of relevant information according to the present embodiment.

FIG. 13 is a diagram illustrated to describe an example of a questionnaire entry screen according to the present embodiment.

### MODE(S) FOR CARRYING OUT THE INVENTION

Hereinafter, (a) preferred embodiment(s) of the present disclosure will be described in detail with reference to the appended drawings. Note that, in this specification and the appended drawings, structural elements that have substantially the same function and structure are denoted with the same reference numerals, and repeated explanation of these structural elements is omitted.

Moreover, the description will be given in the following order.

### 1. Overview of Learning Support System According to One Embodiment of Present Disclosure

### 2. Configuration

### 2-1. Configuration of User Terminal

### 2-2. Configuration of Server

### 3. Processing of Operation

### 3-1. Question-Setting Control Processing

### 3-2. Display Control Processing of Each Question

### 4. Conclusion

### <<1. Overview of Learning Support System According to One Embodiment of Present Disclosure>>

A learning support system according to an embodiment of the present disclosure sequentially presents a question and a predetermined relevant question used to derive a correct answer to the question depending on elapsed time in presenting the question to a learner using a computer and determines a next question to be presented depending on an answer of the relevant question.

### BACKGROUND

The accurate measurement of learner's abilities using IRT necessitates the learner to solve a large quantity of questions as described above. This however puts a heavy burden on the learners who are to solve a large quantity of questions in bulk inquiring about their abilities to think, judge, express, or the like as a tendency of questions in recent educational environments around the world. In addition, preparing a large quantity of questions in bulk is also heavy burden to a person who prepares a question (e.g., teacher and lecturer). In addition, for a question inquiring about the ability to think, judge, express, or the like, the process of how to reach an answer to the question is necessary to be considered to achieve accurate understanding of the ability and comprehension level of the learner.

Further, the recent development of information technology implements computer-based testing (CBT), and so it is possible to conduct tests all over the world simultaneously without physically gather in one place. However, it is difficult to evaluate accurately a large quantity of questions as described above in a manner in which an answer is given to each question, resulting in difficulty in implementing the CBT.

Thus, the learning support system according to the present embodiment, in presenting a test question to a learner, presents one or more of the relevant questions used to derive a correct answer to the question depending on the elapsed time and determines a next question depending on a correct answer to the relevant question, thereby improving learning efficiency. Specifically, it is possible to segment the process of how the learner reaches an answer and to evaluate the learner on the basis of the answer to the relevant question even if the questions are large in quantity, thus the comprehension level of the learner can be understood more accurately. Thus, in one example, in a case where one or more of the presented relevant questions are all correct, the learning support system according to the present embodiment can judge that the learner fully comprehends the questions, and subsequently can perform control so that different types of questions may be set. In addition, it is possible to segment the process of how to reach answers to a large quantity of questions inquiring about the ability to think, judge, express, or the like and to evaluate the learner. Thus, the application of IRT or implementation of CBT can be achieved easily without setting a large quantity of questions in bulk.

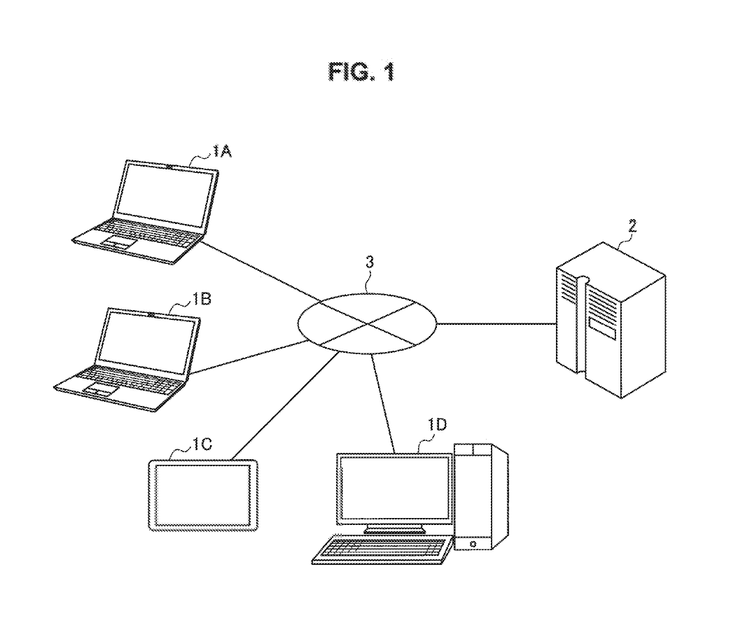

The overall configuration of the learning support system according to the present embodiment as described above is now described with reference to FIG. 1. FIG. 1 is a diagram illustrated to describe the overall configuration of the learning support system according to an embodiment of the present disclosure. In the illustrated example, a user terminal 1 and a server 2 are connected via a network 3. The user terminal 1 is an information communication terminal, and may be implemented as, in one example, a personal computer (PC), a tablet terminal, a smartphone, and a wearable terminal, such as head mounted displays (HMDs), smart watches, smart bands, or smart glasses (light transmission type eyeglass terminal). The user terminal 1 can be used not only by a learner but also by a person who prepares a test question. In FIG. 1, in one example, the notebook PC-type user terminals 1A and 1B, the tablet terminal-type user terminal 1C, and the desktop PC-type user terminal 1D are illustrated. In addition, the user terminal 1 is connected to the network 3 by wire or wirelessly, and exchanges data with the server 2 over the network. In one example, the user terminal 1 displays question data received from the server 2 on the screen, and transmits answer data that is entered by the learner to the server 2.

The server 2 has a database in which the question data is stored. The question data is produced by, in one example, a person who prepares the question using the user terminal 1, and is transmitted to the server 2 via the network 3. The term “question data”, as used herein, includes one or more question data included in a test and includes the correct answer data, comment data, and relevant information of the question, which are associated with each question data. The relevant information is a relevant question (a quiz type hint, hereinafter also referred to as a mini quiz) or a hint used to derive correct answer to the question as described above. The server 2 transmits the question data and relevant information to the user terminal 1 in response to an access from the user terminal 1.

Further, the server 2 performs scoring processing of the question on the basis of the answer data received from the user terminal 1. Furthermore, the server 2 according to the present embodiment can calculate the comprehension level of the learner on the basis of the learner's answer to the mini quiz presented in the process until the question is solved. In addition, the server 2 can determine a next question to be presented on the basis of the answer to the mini quiz, thereby improving the learning efficiency.

The overview of the learning support system according to an embodiment of the present disclosure is described above. Subsequently, the configuration of each component included in the learning support system according to the present embodiment is described in detail.

### <<2. Configuration>>

### <2-1. Configuration of User Terminal>

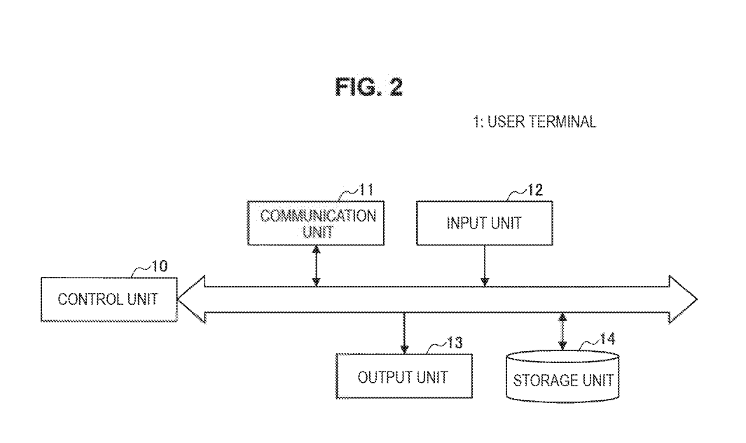

FIG. 2 is a block diagram illustrating a configuration example of the user terminal 1 according to the present embodiment. As illustrated in FIG. 2, the user terminal 1 includes a control unit 10, a communication unit 11, an input unit 12, an output unit 13, and a storage unit 14.

The control unit 10 functions as an arithmetic processing unit and a control unit, and controls the overall operation in the user terminal 1 in accordance with various programs. The control unit 10 is implemented by, in one example, an electronic circuit such as a central processing unit (CPU) and a microprocessor. In one example, the control unit 10 performs control so that question data received from the server 2 via the communication unit 11 is output from the output unit 13, or performs control so that answer data input through the input unit 12 is transmitted to the server 2 via the communication unit 11. Alternatively, the control unit 10 performs control so that a question preparing screen received from the server 2 is output from the output unit 13, or performs control so that the question data input through the input unit 12 is transmitted to the server 2 via the communication unit 11.

The communication unit 11 is a communication module for transmitting or receiving data to or from other devices by wire or wirelessly. In one example, the communication unit 11 is connected to the network 3 and communicates with the server 2 over the network. In one example, the communication unit 11 receives the question data from the server 2 and transmits the answer data that is entered by the learner.

The input unit 12 has a function of accepting information input from the outside to the user terminal 1. In one example, the input unit 12 can be implemented as a touch panel, a switch, a keyboard, a mouse, a button, a microphone, a camera, or various sensors (e.g., accelerometer, position sensor, biometric sensor, etc.). More specifically, the input unit 12 acquires answer data to the question presented by the output unit 13, and sends it to the control unit 10.

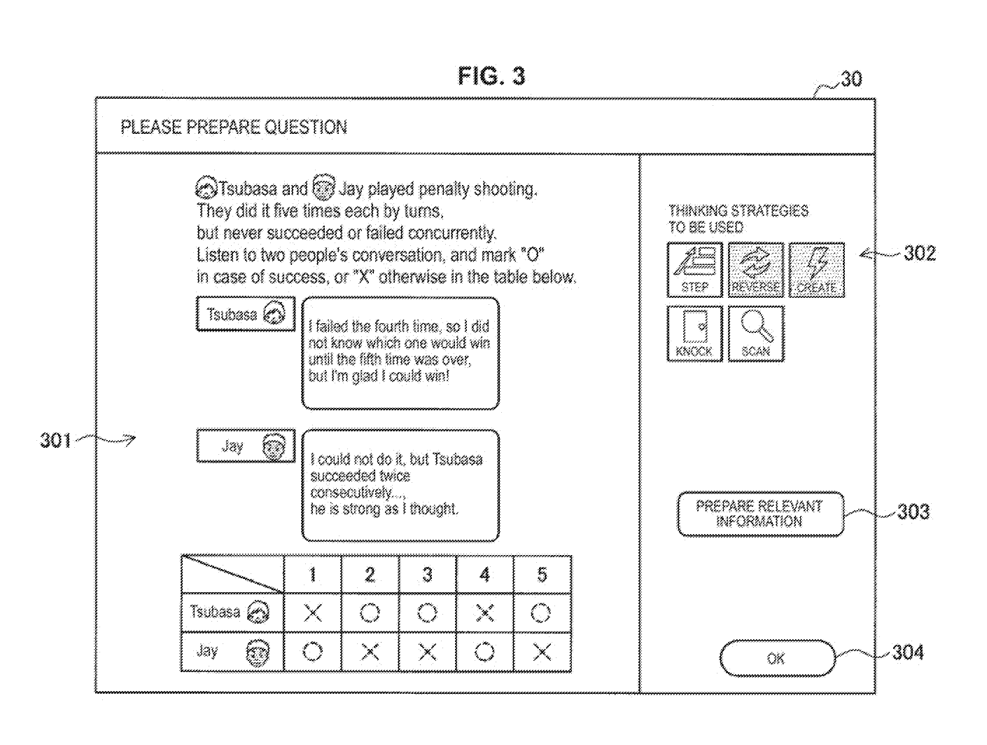

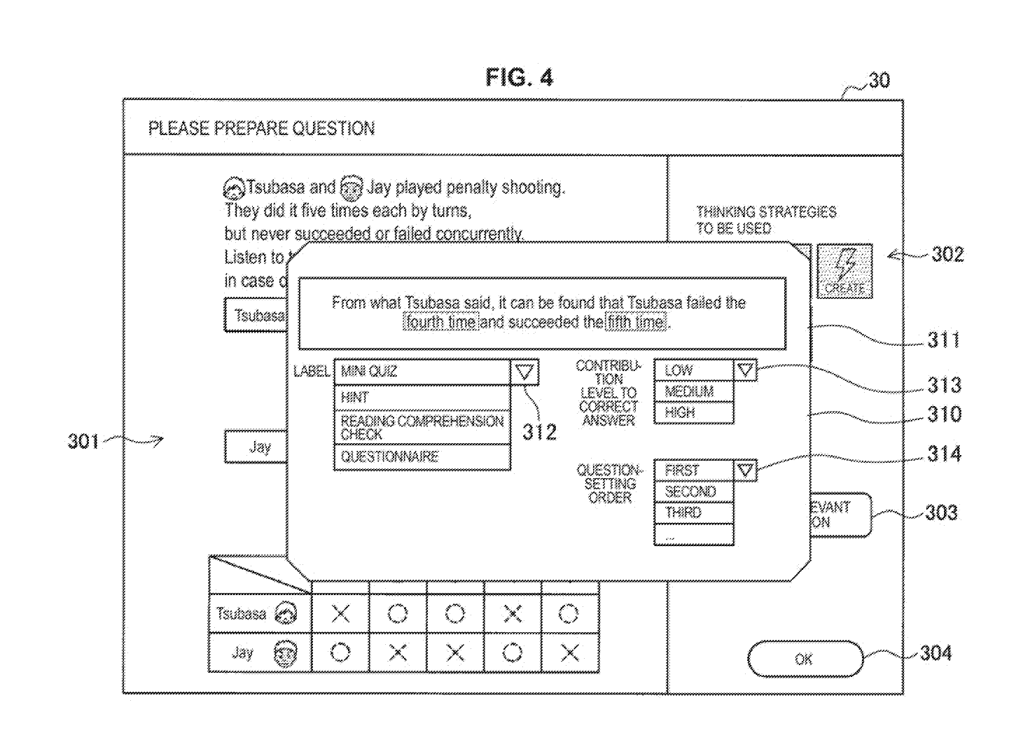

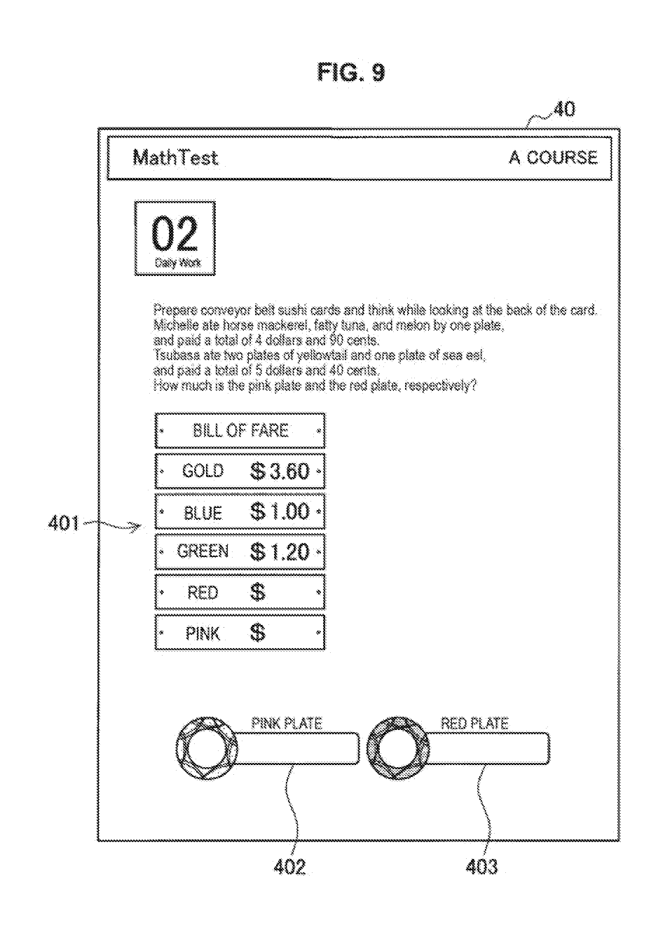

The output unit 13 has a function of outputting information using video, image, sound, or the like. In one example, the output unit 13 is implemented as a display unit and/or a speaker, and outputs a question presentation screen on the basis of question data transmitted from the server 2. An example of the question presentation screen according to the present embodiment will be described later with reference to FIGS. 9 to 13. In addition, the output unit 13 can also display a question preparing screen. The user terminal 1 can also be used when the question preparing person prepares a test question. An example of the question preparing screen is now described with reference to FIGS. 3 and 4.

FIG. 3 is a diagram illustrating an example of the question preparing screen according to the present embodiment. In the illustrated example, a question preparing screen 301, a thinking strategy setting screen 302, a relevant information preparing button 303, and an OK button 304 are displayed on the screen 30. In the question preparing screen 301, texts and charts are entered by the person who prepares a question, and the question presentation screen is created. In addition, it is also possible to enter an answer (correct answer data) and a comment on the question preparing screen 301. In the example illustrated in FIG. 3, an answer is entered using a check-cross mark in a table below the question preparing screen 301. Such an answer can be presented when the learner checks an answer or when a teacher views it.

The thinking strategy setting screen 302 is a screen used to set a thinking strategy assumed to be used to derive an answer through the question. The thinking strategy used to solve the question is not particularly limited, but in one example, it is assumed to be classified into thinking strategies of “step”, “reverse”, “create”, “knock”, and “scan”. The “step strategy” is a solid thinking strategy that steadily derives the answer from certain reasons and that does not proceed to an uncertain path. The “reverse strategy” is a thinking strategy that thinks to be given or assumed result, and that clarifies the way to proceed by thinking base don results, “create strategy” is a thinking strategy that changes the way of thinking that creates hints yourself by changing forms and viewpoints and that is a thinking strategy which sometimes requires a sense awareness before searching for a certain reason. The “knock strategy” is a thinking strategy that advances by checking whether it is correct by applying possible possibility while verifying it one by one. The “scan strategy” is a thinking strategy that organized information firmly by finding out necessary information and unnecessary information and that firmly find the essence of the question. In the present embodiment, it is possible to classify each question depending on the thinking strategy that is set for each question. In addition, one or a plurality of thinking strategies may be set for each question.

The relevant information preparing button 303 is a button used to prepare information for deriving a correct answer to the question such as a mini quiz or a hint. Here, FIG. 4 illustrates an example of a relevant information preparing screen.

As illustrated in FIG. 4, when the preparing button 303 is selected, the relevant information preparing screen 310 is displayed in a pop-up form on the screen 30. The relevant information preparing screen 310 includes a relevant information input column 311, a label setting column 312, a column for setting contribution level to correct answer 313, and a relevant information question-setting order setting column 314. In the relevant information input column 311, a mini quiz (alternative answering way or free entry answering way), a hint (with/without checkbox to check what you read), a reading comprehension check quiz (with/without checkbox to check what you read), or a simple questionnaire (alternative answering way or free entry answering way) can be input as the relevant information using at least texts or charts. In the label setting column 312, whether the relevant information is, in one example, a mini quiz, a hint, a reading comprehension check quiz, or a simple questionnaire is set. In one example, in the case where the mini quiz label is selected, a mini quiz in which a predetermined item (“fourth time” and “fifth time” in the example illustrated in FIG. 4) selected among the relevant information items that are input in the relevant information input column 311 is created. In the column for setting contribution level to correct answer 313, the contribution level (i.e., the magnitude of hint) that derives the correct answer to the relevant information is set. In the question-setting order setting column 314, the order of setting the relevant information sequentially presented depending on the elapsed time (which information is to be presented in what order) is set. Moreover, although not illustrated in FIG. 4, in the case where the relevant information is a mini quiz, thinking strategies assumed to be used for deriving the answer to the mini quiz (e.g., “step strategy”, “reverse strategy”, “create strategy “knock strategy”, or “scan strategy”) can also be set.

The OK button 304 is a button that is selected in the case where the preparing of a question is completed. The determined question data, which is selected by the OK button 304, is transmitted to the server 2 and registered in a question data DB 22.

The storage unit 14 is implemented by a read-only memory (ROM) that stores various programs, operation parameters, or the like used for the processing in the control unit 10, and a random-access memory (RAM) that temporarily stores a parameter that varies as appropriate.

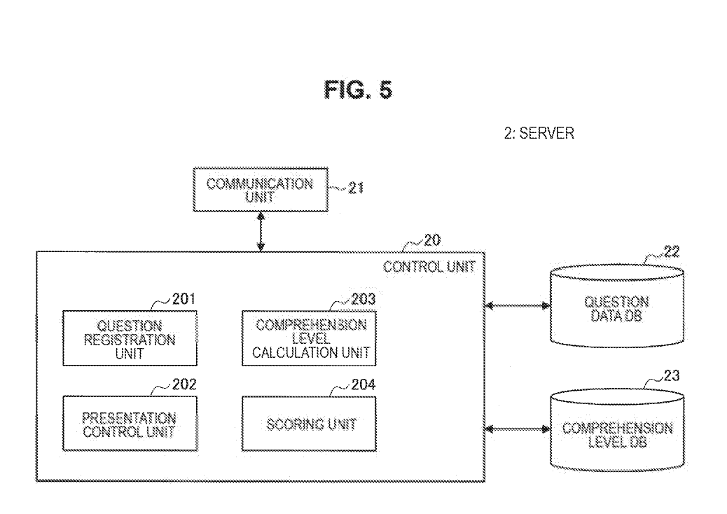

The configuration example of the user terminal 1 according to the present embodiment is described in detail above. Subsequently, a configuration example of the server 2 is described with reference to FIG. 5.

### <2-2. Configuration of Server>

FIG. 5 is a block diagram illustrating a configuration example of the server 2 according to the present embodiment. As illustrated in FIG. 5, the server 2 includes a control unit 20, a communication unit 21, a question data database (DB) 22, and a comprehension level database (DB) 23.

The control unit 20 functions as an arithmetic processing unit and a control unit, and controls the overall operation in the server 2 in accordance with various programs. The control unit 20 is implemented by, in one example, an electronic circuit such as a CPU or a microprocessor. In addition, the control unit 20 according to the present embodiment functions as a question registration unit 201, a presentation control unit 202, a comprehension level calculation unit 203, and a scoring unit 204, as illustrated in FIG. 5.

The question registrations unit 201 has a function of storing question data in the question data DB 22. The question data includes one or more question data included in the test and includes correct answer data, comment data and relevant information, which are associated with each question, as described above.

The presentation control unit 202 controls presentation of question data to the user terminal 1 by using various data stored in the question data DB 22. In one example, the presentation control unit 202 extracts question data to be presented (to be set) to the learner from the question data DB 22 and performs control so that the question data is transmitted to the user terminal 1 via the communication unit 21. In the user terminal 1, the output unit 13 outputs a question display screen on the basis of the received question data. In addition, the presentation control unit 202 performs control so that the relevant information is output sequentially depending on the elapsed time from output of the question display screen to input of the answer. In one example, the presenter control unit 202 performs control so that the relevant information is sequentially transmitted to the user terminal 1 and is presented via the communication unit 21 depending on the time elapsed from presentation of question data to the learner by the user terminal 1. Alternatively, the presentation control unit 202 previously transmits one or more relevant information items to the user terminal 1, and the control unit 10 of the user terminal 1 may issue a control instruction so that the relevant information is sequentially presented depending on the time elapsed from the presentation of the question data. The relevant information (specifically, mini quiz or hint) can be presented sequentially in the order of ascending contribution levels that derive a correct answer depending on the elapsed time.

Further, the presentation control unit 202 according to the present embodiment determines a next question to be presented to the learner on the basis of at least one of the learner's answer to the question, the learner's answer to the mini quiz, and the hint presented to the learner. In one example, in a case where the answer to the presented mini test is correct and the answer to the question is correct, the presentation control unit 202 judges that the learner comprehends the question and determines a different question (e.g., a question testing different thinking strategy) as the next question to be presented. On the other hand, in a case where an answer to the presented mini test is incorrect or a case where an answer to the mini test is correct but the answer to the question is incorrect, the presentation control unit 202 judges that the learner does not comprehend the question or that the learner makes a mistake due to minor mistake, and determines a similar type question as the next question. This makes it possible to prevent a similar type question from being presented to the learner who fully comprehends the question, thereby improving the learning efficiency. In addition, it is possible to calculate the comprehension level of the learner more accurately without causing a large quantity of questions to be solved.

Furthermore, the presentation control unit 202 may determine the relevant information to be presented in a question to be set next, depending on which mini quiz the student correctly answered. In one example, in the case where the answer to the mini test is correct and the answer to the question is correct, the presentation control unit 202 may perform control so that a mini test having the equivalent contribution level may be skipped and a mini test having lower contribution level may be presented in the next question. In addition, in the case where the answer to the mini test is correct and the answer to the question is incorrect, the presentation control unit 202 performs control so that a mini test having lower contribution level may be presented in the next question. In addition, in one example, in the case where the answer to the presented mini test is incorrect and the answer to the question is incorrect, the presentation control unit 202 performs control so that more detailed mini test (contribution level that derives a correct answer is larger) is presented in the next question.

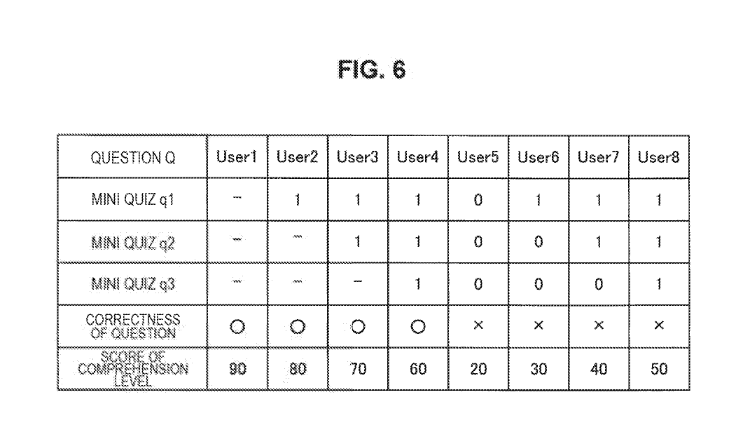

The comprehension level calculation unit 203 calculates the learner's comprehension level to the question on the basis of at least one of the learner's answer to the question, the learner's answer to the mini quiz, and the hint contents presented to the learner. The comprehension level may be digitized as a comprehension level score. The comprehension level calculation according to the present embodiment is now described with reference to FIG. 6. FIG. 6 is a diagram illustrated to describe the comprehension level calculating method according to the present embodiment. In the illustrated example, in a case where a mini quiz q1, a mini quiz q2, and a mini quiz q3 are set for a question Q, an example of calculation of the comprehension level score based on the correctness of the presented mini quiz and the correctness of the question is illustrated. The mini quizzes q1 to q3 derive the correct answer of the question, and they are presented sequentially depending on the passage of time. In the example illustrated in FIG. 6, the correctness of the mini quizzes q1 to q3 is indicated by “0 (incorrect answer) “”1 (correct answer)”, and the correctness of the question Q is indicated by “circle mark (correct answer)” “cross mark (incorrect answer)”. In addition, in the mini quizzes q1 to q3, the contribution levels that derive the correct answer are assumed to be set in the descending order in the order presented depending on the passage of time.

In one example, as shown in the answer example of the user 1 in FIG. 6, in a case where an answer is entered without presenting one mini quiz and that the answer is correct, it is assumed to be fully comprehended, and the comprehension level calculation unit 203 calculates, in one example, a comprehension level score as 90. In addition, as shown in the answer example of user 2, in a case where an answer is entered to one mini quiz and the answer is correct, the correct answer is given by obtaining one hint, and so the comprehension level is calculated as 80, which is lower than the case of the user 1. In addition, as shown in the answer example of user 3, in a case where answers are entered to two presented mini quizzes and the answers are correct, the correct answers are given by obtaining two hint, and so the comprehension level score is calculated as 70, which is lower than the case of the user 2. In addition, as shown in the answer example of user 4, in a case where answers are entered to three presented mini quizzes and the answers are correct, the correct answers are given by obtaining three hints, and so the comprehension level score is calculated as 60, which is lower than the case of the user 3. In the calculation of a comprehension level based on the answer examples of the users 2 to 4 described above, the scores decrease by 10 depending on the number of presented mini quizzes. However, the calculation of comprehension level score is limited to the present embodiment, and the calculation may be performed by adding a weight corresponding to the contribution level that derives the correct answer of each presented mini quiz. In other words, in the case where the correct answer is given by obtaining a hint having a larger contribution level the comprehension score is calculated to be lower than the case where the correct answer is given by obtaining a hint having a tower contribution level.

Further, as shown in the answer example of the user 5 in FIG. 6, in a case where answers to three presented mini quizzes are all incorrect and the answers to the question are incorrect, it is assumed that the comprehension is insufficient, and the comprehension level calculation unit calculates, in one example, she comprehension level score as 20. In addition, as shown in the answer example of the user 6, in a case where an answer to the mini quiz q is correct but answers to the mini quizzes q2 and q3 are incorrect and the answers to the question are incorrect, it is insufficient previously though it can be said that the comprehension level is higher than that of the user 5, and so the comprehension level score is calculated as 30. In addition, as shown in the answer example of the user 7, in a case where answers to the mini quizzes q1 and q2 are correct but an answer to the mini quiz q3 is incorrect and the answers to the question are incorrect, the comprehension level score is calculated as 40, which is higher than the case of the user 6. In addition, as shown in the answer example of the user 8, in a case where answers so the mini quizzes q1, q2, and q3 are correct but the answers to the question are incorrect the comprehension level score is calculated as 50, which is higher than the case of the user 7. In the calculation of a comprehension level based on the answer examples of the users 5 to 8 described above, the scores change by 10 depending on the correctness for the three presented mini quiz. However, the calculation of comprehension level score is limited to the present embodiment, and the score may be changed by adding a weight depending on the contribution level that derives the correct answer of each presented mini quiz. More specifically, in one example, in the case where the answer to the mini quiz having a large-contribution level is correct and the answer to the question is incorrect, the comprehension level score is calculated to be higher than the case where the answer to the mini quiz is incorrect and the answer to the question is incorrect.

The example of calculation of the comprehension level score based on the correctness of the presented mini quiz and the correctness of the question is described above, but the present embodiment is not limited thereto. In one example, the comprehension level calculation unit 203 may estimate the thinking strategy used by the learner from the answer to the question and/or the answer to the mini quiz, and may calculate the comprehension level on the basis of whether the optimum thinking strategy (e.g., the thinking strategy set at the time of preparing questions) is used.

The scoring unit 204 refers to the correct answer data stored in the question data DB 22, judges whether the answer to the question transmitted from the user terminal 1 is correct, and calculates the score of the test including one or more questions. The scoring unit 204 calculates the score of the test separately from the calculation of the comprehension level, and so, in one example, in the example illustrated in FIG. 6, the answers to all the questions are correct, so equivalent score addition processing is performed. Moreover, the scoring processing according to the present embodiment is not limited thereto, and in one example, the scoring unit 204 may calculate the score by performing weighting depending on the comprehension level for each question that is calculated by the comprehension level calculating unit 203.

The communication unit 21 is a communication module for transmitting and receiving data to and from other devices by wire or wirelessly. In one example, the communication unit 21 is connected to the network 3 and communicates with the user terminal 1. In one example, the communication unit 21 transmits question data to the user terminal 1, and receives answer data that is entered by the learner from the user terminal 1.

The question data DB 22 is a storage unit that scores the question data. The stored question data includes one or more question data included in the test, and includes correct answer data, comment data, and relevant information of the question, which are associated with each question data.

The comprehension level DB 23 is a storage unit that stores the comprehension level calculated by the comprehension level calculating unit 203.

The configuration example of the server 2 according to the present embodiment is described in detail above. Moreover, the configuration example of the server 2 is not limited to the example illustrated in FIG. 3, and in one example, various databases (question data DB 22 or comprehension level DB 23) may be provided in an external device connected to the server 2.

### <<3. Processing of Operation>>

### <3-1. Question-Setting Control Processings

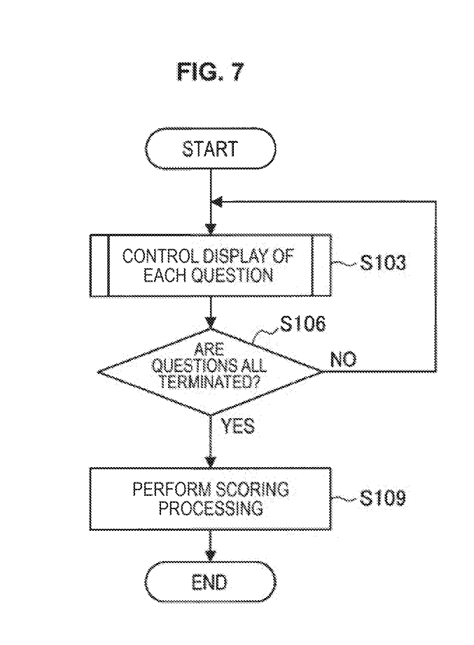

Subsequently, processing of an operation according to the present embodiment is described. FIG. 7 is a flowchart illustrating the question-setting control processing according to the present embodiment.

As illustrated in FIG. 7, first, the server 2 controls a display of each question to the user terminal 1 (step S103). In one example, the server 2 performs control so that the questions are displayed (to be set) one by one on the user terminal 1 and repeats the display control until all the questions are terminated (step S106).

Next, in the case where the questions are all terminated (Yes in step S106), the server 2 performs the scoring processing on the basis of the answer data to the question that is transmitted from the user terminal 1 (step S109). Specifically, in the server 2, the scoring unit 204 checks the correctness of the answer data to the question that is transmitted from the user terminal 1 by referring to the correct answer data stored in the question data DB 22 and calculates the score.

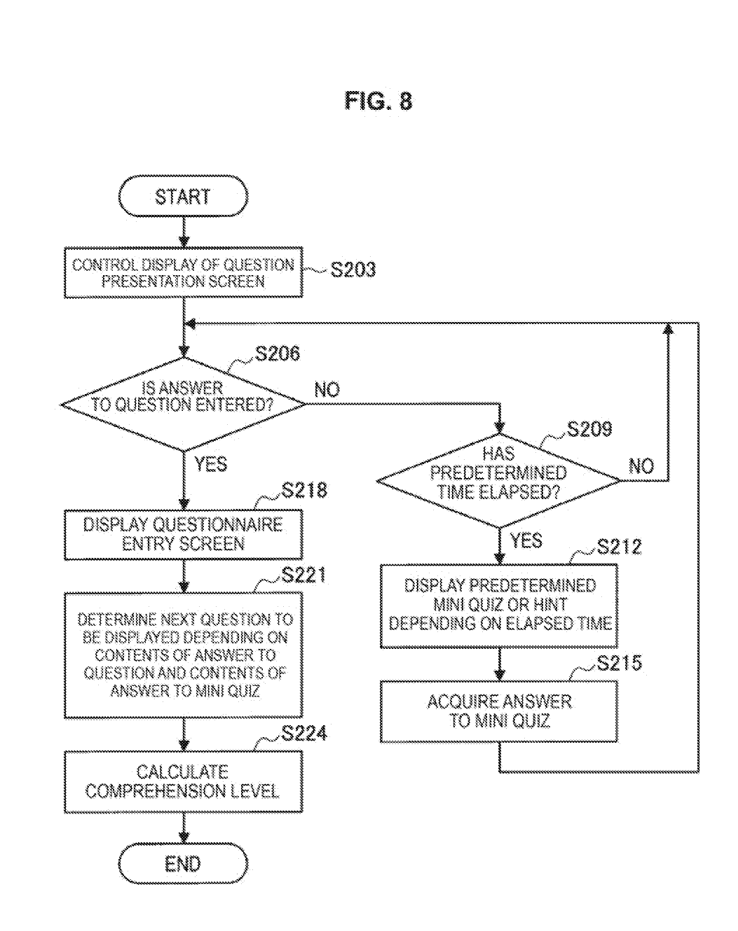

The question-setting control processing according to the present embodiment is described in detail above. Subsequently, the display control of each question shown in S103 is described with reference to FIG. 8.

### <3-2. Display Control Processing of Each Question>

FIG. 8 is a flowchart illustrating the display control processing of each question according to the present embodiment. As illustrated in FIG. 8, in the server 2, the presentation control unit 202 performs control so that the question presentation screen is displayed on the user terminal 1 (step S203).

Next the server 2 counts the time until the answer to the question is entered in the user terminal 1, and judges whether a predetermined time has elapsed for a period of time during no answer is entered (No at step S206 and S209).

Next, in a case where the predetermined time has elapsed for which no answer is entered (Yes in step S209), the presentation control unit 202 of the server 2 performs control so that the relevant information, such as a predetermined mini quiz or hint, is displayed on the user terminal 1 depending on the elapsed time (Step S212). The relevant information is used to derive a correct answer to a question, and it is possible for the learner to obtain a clue to the answer of the question by checking the relevant information.

Subsequently, in the case where the mini quiz is presented at the user terminal 1, the server 2 acquires an answer to the mini quiz (step S215).

Then, in a case where a predetermined time has elapsed without the answer being entered previously, the presentation control and 202 performs control so that the next relevant information is displayed, and in a case where the mini quiz is presented, the presentation control unit 202 acquires the answer to the mini quiz (steps S206 and steps S209 to S215). In this manner, the presentation control unit 202 sequentially displays the relevant information depending on the elapsed time (repetition of steps S209 to S215) until an answer to the question is entered (step S206), and gives the learner a hint for solving the question. A specific example of the question presentation screen and the relevant information presentation screen according to the present embodiment is now described with reference to FIGS. 9 to 11.

FIG. 9 is a diagram illustrated to describe an example of the question presentation screen according to the present embodiment. In the illustrated example, a question 401, and answer columns 402 and 403 are displayed on a screen 40. The learner checks the question 401, solves the question, and enters the answer in the answer columns 402 and 403. The answers that are input in the answer columns 402 and 403 are transmitted from the user terminal 1 to the server 2 as answer data to the question.

In the present embodiment, in the case where no answer is entered in the answer columns 402 and 403 until a predetermined time has elapsed after displaying the question 401, the presentation control unit 202 of the server 2 causes the relevant information used to derive the answer to the question 401 to be displayed sequentially depending on the elapsed time. The order of the time axis for displaying the relevant information may be set by the question-setting order setting column 314 as described with reference to FIG. 4. The order of setting questions can be typically set in the ascending order of contribution levels to the correct answer.

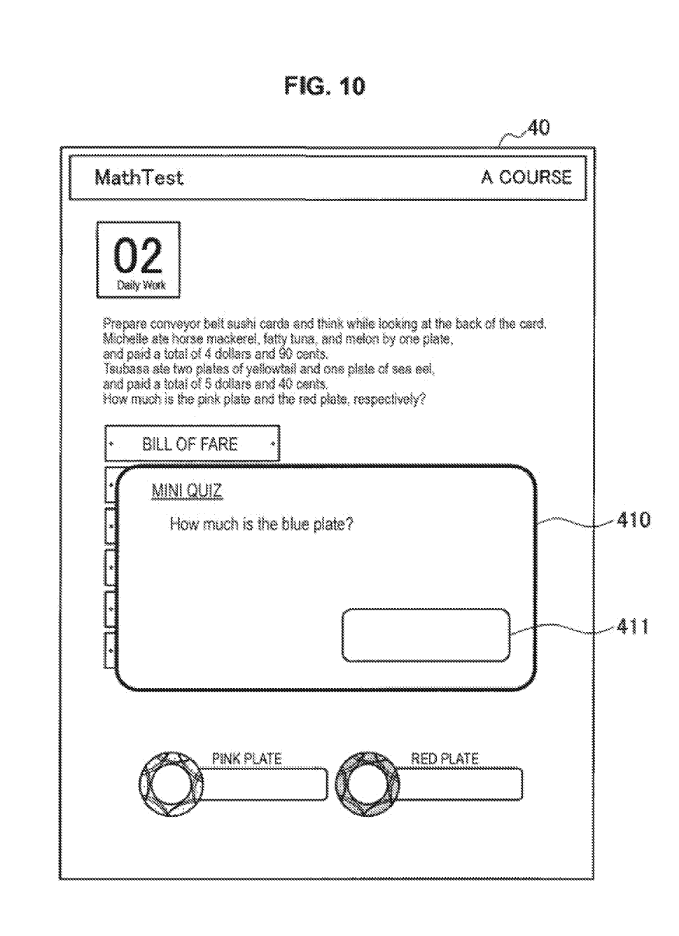

Specifically, in one example, as illustrated in FIG. 10, a mini quiz 410 that is an example of relevant information is displayed in a pop-up form on the screen 40. The mini quiz 410 includes an answer column 411, and the answer entered in the answer column 411 is transmitted from the user terminal 1 to the server 2 as answer data to the mini quiz 410.

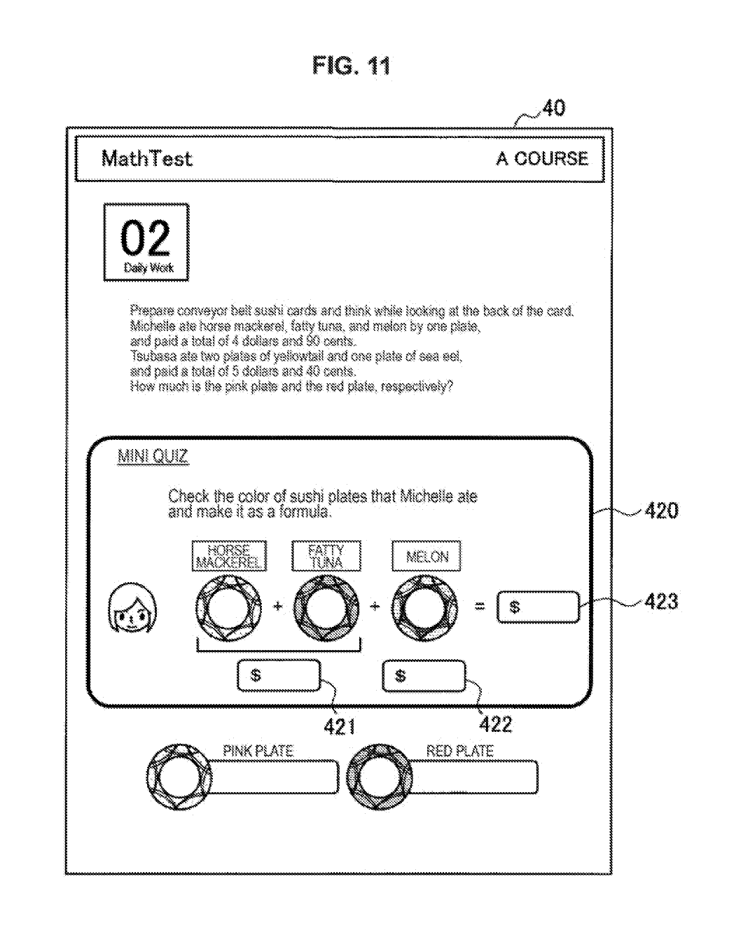

Next, in a case where the learner does not enter an answer to the question for a predetermined time even after solving the mini quiz 410, the presentation control unit 202 of the server 2 performs control so that the next relevant information having a contribution level higher than that of the mini quiz 410 is presented. Specifically, in one example, as illustrated in FIG. 11, a mini quiz 420 that is an example of relevant information is displayed in a pop-up form on the screen 40. The mini quiz 420 includes answer columns 421, 422, and 423, and the answers entered in the answer columns 421, 422, and 423 are transmitted from the user terminal 1 to the server 2 as answer data to the mini quiz 420.

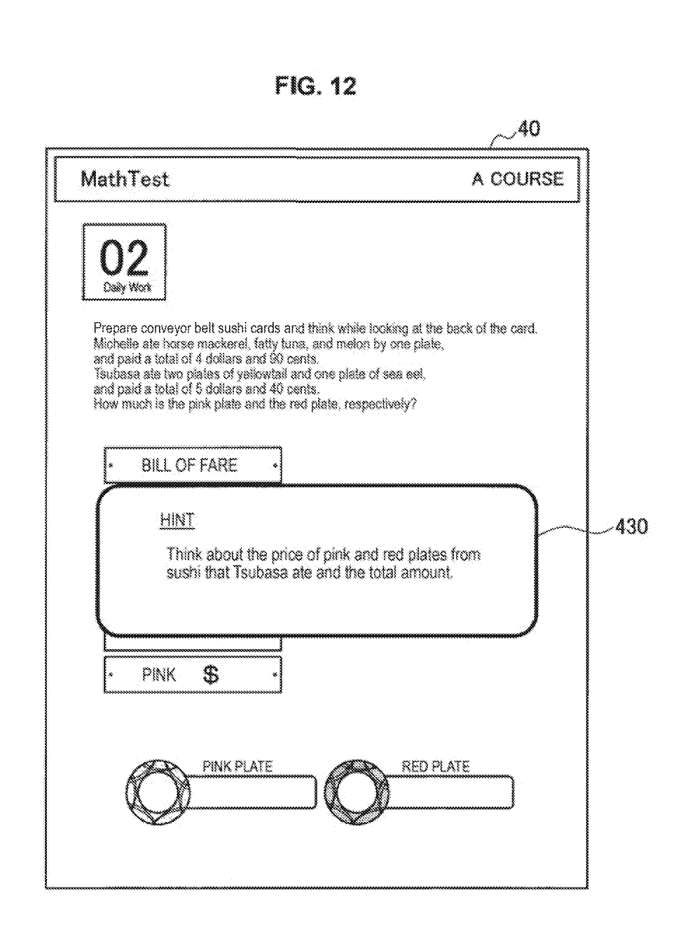

Subsequently, in the case where the learner does not enter an answer to the question answer for a predetermined time even after solving the mini quiz 420, the presentation control unit 202 of the server 2 performs control so that the next relevant information having a contribution level to correct answer higher than that of the mini quiz 420 is presented. Specifically, in one example, as illustrated in FIG. 12, a hint 430 that is an example of the relevant information is displayed in a pop-up form on the screen 40. Moreover, although not illustrated in FIG. 12, a check box for checking that the hint is read may be included in 430.

The specific examples of the question-setting screen example and the relevant information presenting screen example are described above.

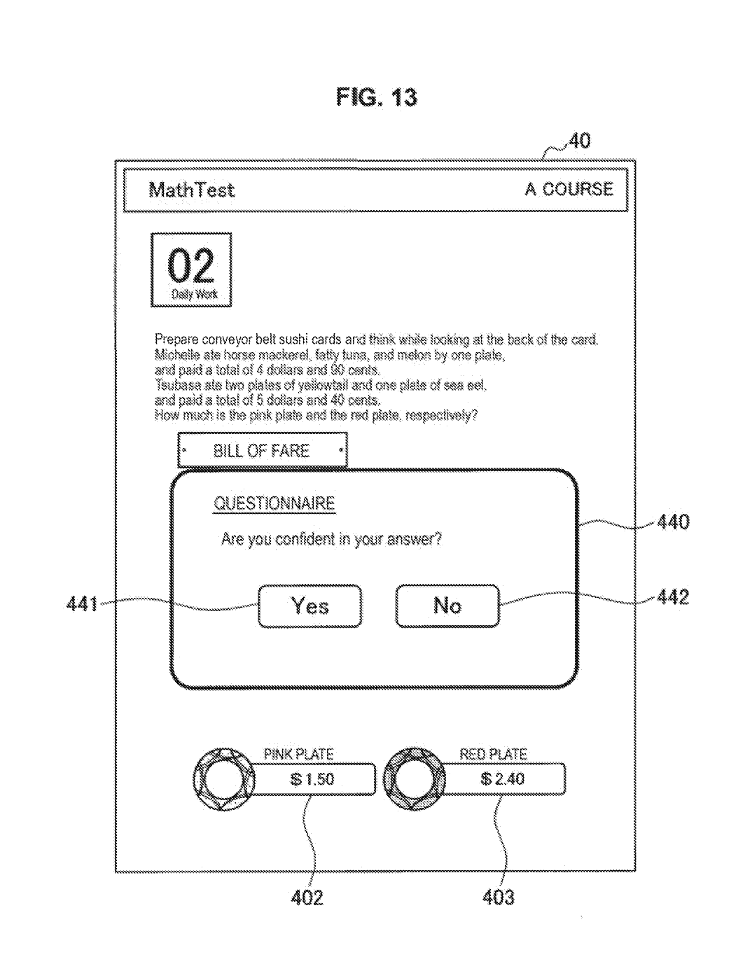

Next, referring back to FIG. 8, in the case where an answer to the question is entered (Yes in step S206), the presentation control unit 202 of the server 2 performs control so that a questionnaire entry screen is displayed on the user terminal 1 (step S218). The questionnaire entry screen allows the degree of certitude for difficulty as to whether the question currently being solved is difficult to be checked. A specific example of the questionnaire entry screen is now described with reference to FIG. 13.

FIG. 13 is a diagram illustrated to describe an example of the questionnaire entry screen according to the present embodiment. In the illustrated example, a questionnaire entry screen 440 is displayed in a pop-up form on the screen 40. The questionnaire entry screen 440 includes a Yes button 441 and a No button 442, and allows the learner to select Yes or No depending on whether the learner has confidence in the answer. The selected information is transmitted from the user terminal 1 to the server 2 as a questionnaire result. In the example illustrated in FIG. 13, a text, “Are confident in the answer?”, is displayed, but the present embodiment is not limited thereto, and the degree of certitude of the learner for the question may be directly checked, by a text, “Is the question difficult?” in one example. In addition, the way of answering to questionnaire is not limited to the selection of Yes/No as illustrated in FIG. 13, and may be an alternative answering way or a free entry answering way.

Subsequently, the presentation control unit 202 of the server 2 determines the next question to be presented depending on contents of the answer to the question and contents of the answer to the mini quiz by the learner (step S221). Specifically, in one example, the presentation control unit 202 determines whether the same type of next question is present or different type of next question is present (e.g., a question whose thinking strategy supposed to be used for solving a question is the same) on the basis of the correctness of the question and the correctness of the mini quiz. In addition, the presentation control unit 202 may determine the relevant information to be presented in the next question to be presented on the basis of the correctness of the question and the correctness of the mini quiz. Specifically, in one example, the presentation control unit 202 skips the relevant information of the contribution level that is equivalent to the mini quiz correctly answered to the current question in the next question, or presents the relevant information having the higher contribution level in the next question in the case where the current question is incorrect. Moreover, the presentation control unit 202 may determine the next question to be presented using at least one of the length of answering time to the question, the degree of contribution level of the presented relevant information, the comprehension level of the question calculated in the next step, and the questionnaire result.

Next, the comprehension level calculation unit 203 of the server 2 calculates the comprehension level of the question (step S224). Specifically, in one example, the comprehension level calculation unit 203 can calculate the comprehension level of the question or the basis of contents of the answer to the question by the learner and contents of the answer to the mini quiz by the learner. The calculated comprehension level is stored in the comprehension level DB 23 and is transmitted to the learner, the teacher side, and the test questioner side as necessary.

### <<4. Conclusion>>

An embodiment of the present disclosure is described in detail above with reference to FIGS. 1 to 13. As described above, the learning support system according to the embodiment of the present disclosure makes it possible to determine the next question depending on the answer of the mini quiz for deriving the correct answer of the question, thereby improving the learning efficiency.

Further, it is possible to calculate the comprehension level with respect to contents of the question more accurately by causing the mini quiz for deriving the correct answer of the question to be solved. In other words, even if the number of questions is small, one or more mini quizzes can be presented for each question, and so it is possible to attach scores with variations in comprehension level. In addition, if the comprehension levels vary, the degree of freedom in determining the next question increases.

The preferred embodiment(s) of the present disclosure has/have been described above with reference to the accompanying drawings, whilst the present disclosure is not limited to the above examples. A person skilled in the art may find various alterations and modifications within the scope of the appended claims, and it should be understood that they will naturally come under the technical scope of the present disclosure.

In one example, a computer program for causing hardware such as a CPU, ROM, and RAM incorporated in the user terminal 1 or the server 2 described above to implement its functions can be created. In addition, a computer readable storage medium storing the computer program is also provided.

Further, in the above-described embodiment, it is described that the relevant information (including mini quiz) is sequentially presented depending on the elapsed time. However, the present embodiment is not limited thereto, and it is also possible to change the setting of the presentation method on the way. In one example, the presentation control unit 202 of the server 2 can change the time interval for presenting the relevant information depending on the correctness of the question or mini quiz that previously solved by the learner. In addition, the time interval for presenting the relevant information may be set or changed by the user such as a learner or a test questioner.

Further, the presentation control unit 202 of the server 2 may perform control so that “unknown button” is displayed on the question presentation screen and relevant information is presented in the case where the button is selected.

Further, the presentation control unit 202 of the server 2 may determine relevant information to be presented next depending on the correctness of the answer to the presented mini quiz. In one example, in the case where the answer to the mini quiz is incorrect, the presentation control unit 202 may perform control so that relevant information such as a hint or mini quiz that is simpler (i.e., higher contribution level that derives a correct answer) is presented.

Some of the components of the control unit 20 of the server 2 illustrated in FIG. 5 may be provided in the user terminal 1.

Further, the effects described in this specification are merely illustrative or exemplified effects, and are not limitative. That is, with or in the place of the above effects, the technology according to the present disclosure may achieve other effects that are clear to those skilled in the art from the description of this specification.

Additionally, the present technology may also be configured as below.

(1)

An information processing device including:

a communication unit configured to transmit a question and a relevant question to a client terminal and receive an answer to the relevant question from the client terminal, the relevant question being presented with passage of time and being used to derive an answer to the question; and

a control unit configured to determine a next question to be transmitted on a basis of the answer to the relevant question.

(2)

The information processing device according to (1), further including:

a calculation unit configured to calculate a comprehension level of the question on the basis of the answer to the relevant question.

(3)

The information processing device according to (2),

in which the calculation unit calculates the comprehension level of the question further on a basis of the answer to the question.

(4)

The information processing device according to (2) or (3), further including:

a scoring unit configured to calculate a score of a test question including one or more of the questions on a basis of the answer to the question and correct answer data stored previously in a question data storage unit.

(5)

The information processing device according to any one of (1) to (4),

in which the control unit determines the next question to be transmitted further on a basis of the answer to the question.

(6)

The information processing device according to any one of (1) to (5),

in which the communication unit transmits a hint necessary for answering the question to the client terminal, the hint being presented with passage of time, and

the control unit determines the next question to be transmitted on a basis of an answer to the relevant question presented at the client terminal and the presented hint.

(7)

The information processing device according to any one of (1) to (6),

in which the control unit performs control so that one or more of the relevant questions are presented sequentially depending on an elapsed time from presentation of the question to entry of an answer in the client terminal.

(8)

The information processing device according to any one of (1) to (7),

in which the control unit determines, on a basis of at least one of correctness of the answer to the relevant question or correctness of the answer to the question, a relevant question to be presented in a next question.

(9)

The information processing device according to (8),

in which the control unit determines the relevant question to be presented in the next question in consideration of a contribution level that derives a correct answer, the contribution level being set in each relevant question.

(10)

The information processing device according to any one of (1) to (9),

in which each question is associated with a predetermined type of a thinking strategy being intended to be used in solving the question, and

the control unit determines, as a next question, a question associated with a type of the thinking strategy that is identical to or different from a type of the thinking strategy associated with the question on a basis of correctness of the answer to the relevant question.

(11)

The information processing device according to (2) or (3),

in which the calculation unit calculates the comprehension level of the question depending on whether a predetermined type of a thinking strategy associated with the question coincides with a type of the thinking strategy estimated to be used when a learner answers the question on the basis of the answer to the relevant question.

(12)

An information processing method executed by a processor, the method including:

transmitting a question and a relevant question to a client terminal and receiving an answer to the relevant question from the client terminal, the relevant question being presented with passage of time and being used to derive an answer to the question; and

determining a next question to be transmitted on a basis of the answer to the relevant question.

(13)

A program causing a computer to function as:

a communication unit configured to transmit a question and a relevant question to a client terminal and receive an answer to the relevant question from the client terminal, the relevant question being presented with passage of time and being used to derive an answer to the question; and

a control unit configured to determine a next question to be transmitted on a basis of the answer to the relevant question.

(14)

An information processing device including:

a communication unit configured to receive a question and a relevant question from a server and transmit an answer to the relevant question to the server, the relevant question being presented with passage of time and being used to derive an answer to the question;

a presentation unit configured to present the question; and

a control unit configured to sequentially present the relevant question to the presentation unit with passage of time,

in which the communication unit receives a next question determined on a basis of the answer to the relevant question.

### REFERENCE SIGNS LIST

1 (1A to 1D) user terminal
10 control unit
11 communication unit
12 input unit
13 output unit
14 storage unit
2 server
20 control unit
201 question registration unit
202 presentation control unit
203 comprehension level calculation unit
204 scoring unit
21 communication unit
22 question data DB
23 comprehension level DB
3 network

1. As information processing device comprising:
a communication unit configured to transmit a question and a relevant question to a client terminal and receive an answer to the relevant question from the client terminal, the relevant question being presented with passage of time and being used to derive an answer to the question; and
a control unit configured to determine a next question to be transmitted on a basis of the answer to the relevant question.

2. The information processing device according to claim 1, further comprising:
a calculation unit configured to calculate a comprehension level of the question on the basis of the answer to the relevant question.

3. The information processing device according to claim 2,
wherein the calculation unit calculates the comprehension level of the question further on a basis of the answer to the question.

4. The information processing device according to claim further comprising:
a scoring unit configured to calculate a score of a test question including one or more of the questions on a basis of the answer to the question and correct answer data stored previously in a question data storage unit.

5. The information processing device according to claim 1,
wherein the control unit determines the next question to be transmitted further on a basis of the answer to the question.

6. The information processing device according to claim 1,
wherein the communication unit transmits a hint necessary for answering the question to the client terminal, the hint being presented with passage of time, and
the control unit determines the next question to be transmitted on a basis of an answer to the relevant question presented at the client terminal and the presented hint.

7. The information processing device according to claim 1,
wherein the control unit performs control so that one or more of the relevant questions are presented sequentially depending on an elapsed time from presentation of the question to entry of an answer in the client terminal.

8. The information processing device according to claim 1,
wherein the control unit determines, on a basis of at least one of correctness of the answer to the relevant question or correctness of the answer to the question, a relevant question to be presented in a next question.

9. The information processing device according to claim 8,
wherein the control unit determines the relevant question to be presented in the next question in consideration of a contribution level that derives a correct answer, the contribution level being set in each relevant question.

10. The information processing device according to claim 1,
wherein each question is associated with a predetermined type of a thinking strategy being intended to be used in solving the question, and
the control unit determines, as a next question, a question associated with a type of the thinking strategy that is identical to or different from a type of the thinking strategy associated with the question on a basis of correctness of the answer to the relevant question.

11. The information processing device according to claim 2,
wherein the calculation unit calculates the comprehension level of the question depending on whether a predetermined type of a thinking strategy associated with the question coincides with a type of the thinking strategy estimated to be used when a learner answers the question on the basis of the answer to the relevant question.

12. An information processing method executed by a processor, the method comprising:
transmitting a question and a relevant question to a client terminal and receiving an answer in the relevant question from the client terminal, the relevant question being presented with passage of time and being used to derive an answer to the question; and
determining a next question to be transmitted on a basis of the answer to the relevant question.

13. A program causing a computer to function as:
a communication unit configured to transmit a question and a relevant question to a client terminal and receive an answer to the relevant question from the client terminal, the relevant question being presented with passage of time and being used to derive an answer to the question; and
a control unit configured to determine a next question to be transmitted on a basis of the answer to the relevant question.

14. An information processing device comprising:
a communication unit configured to receive a question and a relevant question from a server and transmit an answer to the relevant question to the server, the relevant question being presented with passage of time and being used to derive an answer to the question;
a presentation unit configured to present the question; and
a control unit configured to sequentially present the relevant question to the presentation unit with passage of time,
wherein the communication unit receives a next question determined on a basis of the answer to the relevant question.
